(19) United States
(12) Patent Application Publication
(10) Pub. No.: US 2025/0166485 A1
(43) Pub. Date: May 22, 2025

(54) METHOD AND DEVICE FOR PLACING A VEHICLE EMERGENCY CALL

(71) Applicant: AUDI AG, Ingolstadt (DE)

(72) Inventor: Matthias VAITL, Oberschleißheim (DE)

(73) Assignee: AUDI AG, (omitted)

(21) Appl. No.: 18/837,018

(22) PCT Filed: Feb. 9, 2023
(86) PCT No.: PCT/EP2023/053238

§ 371 Date: Aug. 8, 2024

(30) Foreign Application Priority Data
Feb. 8, 2022 (DE) 10 2022 102 843.7

(51) Int. Cl. G08B 25/00; G08B 25/01; G08G 1/01; H04W 4/90

(52) U.S. Cl. CPC G08B 25/005; G08B 25/016; G08G 1/0133; H04W 4/90

(57) ABSTRACT

A method, an emergency call control device, and a vehicle, place an emergency call of the vehicle and include detecting, by the emergency call control device of a vehicle, an accident event and automatically placing the emergency call based on the detected accident event, and providing a voice connection to a primary control center.

### CROSS REFERENCE TO RELATED APPLICATIONS

This application is a U.S. national stage of International Application No. PCT/EP2023/053238, filed on Feb. 9, 2023. The International Application claims the priority benefit of German Application No. 10 2022 102 843.7 filed on Feb. 8, 2022. Both the International Application PCT/EP2023/053238 and the German Application 10 2022 102 843.7 are incorporated by reference herein in their entireties.

### BACKGROUND

Disclosed herein is a method for placing an emergency call from a vehicle, wherein an emergency call control device of a vehicle detects an accident event and automatically places an emergency call based on the detected accident event and provides a voice connection to a primary control center. Also disclosed herein is an emergency call control device for a vehicle and a vehicle.

Methods of the kind mentioned at the beginning are part of different designs in the prior art and serve to automatically request assistance in the event of an accident with a vehicle. In the event of an accident involving the vehicle, the primary control center receives an emergency call placed by the vehicle and/or a call from an occupant of the vehicle and initiates the appropriate assistance on the basis of information transmitted by means of the emergency call and/or the call.

DE 11 2011 101 204 B4 deals with the case in which the primary control center is not reachable or ready to receive and discloses a method for placing an emergency call with which an emergency call control device selects a primary control center from a first list and provides a first connection to the primary control center and, in the event of failure of the first connection, selects a secondary control center from a second list and provides a second connection to the secondary control center.

The emergency call is understood here as a data packet transmitted from the vehicle to the primary control center, which includes information regarding the accident of the vehicle, for example a position of the vehicle or damage to the vehicle. The data packet does not need to be sent over a dedicated data connection. The emergency call control device can send the data packet as an auditory audio signal to the control center like a fax machine.

EP 0 737 952 A1 discloses such a method for placing an emergency call from a vehicle, with which an emergency call control device of the vehicle sends an audio signal encoding a position of the vehicle and other data relating to an accident via a voice connection to a control center, the control center receives the transmitted audio signal and sends a confirmation tone to the emergency call control device. The emergency call control device automatically retransmits the audio signal if it does not receive the confirmation tone.

DE 696 26 187 T2 discloses an automatic emergency call method for a vehicle with which a missing confirmation tone from the control center during a voice connection triggers a re-provision of a voice connection after the end of the voice connection. From WO 2019/143436 A1, on the other hand, a method is known to automatically terminate a voice connection if there is no speech for a predetermined period of time.

If the confirmation tone is missing, the emergency call control device can detect a premature end or an error and probable failure of the emergency call. A failure of the emergency call is generally understood here to mean that the control center does not receive all the information necessary for the suitable, i.e. rapid and effective, provision of assistance. On the other hand, the emergency call is successful if the control center receives all the information necessary for the appropriate assistance.

As an alternative to the above solution, a communication network that provides the vehicle with the connection to the primary control center can also detect a premature termination of the connection.

On this basis, U.S. Pat. No. 6,990,349 B1 discloses a method for placing an emergency call from a vehicle, with which a switching node automatically re-provides a connection provided by a vehicle if the connection ends prematurely and the switching node recognizes the connection as an emergency call from the vehicle.

The voice connection allows the occupant of the vehicle to verbally provide further information beyond the emergency call to the control center, such as a number of injured persons or types of injuries. In this respect, a premature termination of the voice connection can also be unfavorable with regard to the appropriate assistance.

In the above two methods, the reliable detection of a failure of the connection depends on a contribution from a device that is separate from the vehicle. The primary control center must send the confirmation tone and the switching node must recognize the premature termination of the connection and the connection as an emergency call.

### SUMMARY

It is therefore an aspect of the invention to provide a method for placing an emergency call from a vehicle which ensures the success of a voice connection provided by the vehicle. Further aspects of the invention are to provide an emergency call control device for a vehicle and a vehicle.

An example of the invention is a method for placing an emergency call from a vehicle, wherein an emergency call control device of a vehicle detects an accident event and automatically places an emergency call based on the detected accident event and provides a voice connection to a primary control center. A large number of vehicles contain emergency call control devices with a predetermined primary control center, which are configured to automatically provide a voice connection. Accordingly, the method according to an example of the invention can be implemented in many emergency call control devices.

According to an example of the invention, the emergency call control device automatically re-establishes the voice connection when the provided voice connection ends and a duration of the provided voice connection measured by a duration measurement module is less than a predetermined minimum duration. A failure of the voice connection is detected based on the duration of the voice connection. In any case, the verbal provision of information requires a minimum duration of the voice connection. When the minimum duration is not reached, i.e. the duration of the voice connection was insufficient, the emergency call control device can assume a failure of the voice connection with a high probability and can remedy it. In this way, the success of the voice connection provided by the vehicle is ensured.

Re-providing can include a predetermined number of unsuccessful connection attempts. After the voice connection fails, the establishment of a new voice connection may fail, for example, when the primary control center is temporarily unreachable or a temporary connection error occurs. The predetermined number increases the probability for the new voice connection.

Advantageously to provide a further voice connection to a secondary control center after a certain number of unsuccessful connection attempts. The secondary control center can provide the appropriate assistance instead of the primary control center. The primary control center can be provided by a manufacturer of the vehicle for the manufactured vehicles. The secondary control center can be provided for each vehicle on an official basis, i.e. by an official body, regardless of the manufacturer.

The emergency call control device preferably analyzes a call during the provided voice connection and the emergency call control device establishes a further voice connection to a secondary control center when the analyzed call includes a pre-recorded announcement from the primary control center. The pre-recorded announcement prevents the occupant from verbally providing information associated with a failure of the voice connection. The emergency call control device assumes that there is a high probability that a person from the primary control center cannot be reached.

In an example, an artificial neural network of the emergency call control device analyzes the call. The artificial neural network is particularly suitable for recognizing patterns and can be trained simply and, in particular, supervised, to distinguish verbal utterances of a person from verbal utterances of a pre-recorded announcement.

The emergency call control device advantageously re-establishes the further voice connection when the provided further voice connection ends and the duration of the provided further voice connection measured by the duration measurement module is less than the predetermined minimum duration. The emergency call control device evaluates the further voice connection as a failure on the basis of the same criterion as the first original voice connection.

Another example of the invention is an emergency call control device for a vehicle which is designed to detect an accident event and to automatically place an emergency call based on the detected accident event and provide a voice connection to a primary control center. An emergency call control device configuration includes an address, such as a telephone number, of the primary control center. The emergency call control device can include a software program that implements an automatic placement of an emergency call and establishment of a voice connection to the primary control center.

According to an example of the invention, the emergency call control device includes a duration measurement module for measuring a duration of a provided voice connection and the emergency call control device is designed to carry out a method according to an embodiment of the invention for placing an emergency call. The duration measurement module is designed to measure the duration as a time from a start of the voice connection to an end of the voice connection. In this way, the emergency call control device detects a failure of the voice connection and ensures the success of the voice connection.

In an example, the emergency call control device has a variable configuration for determining a number of unsuccessful connection attempts for re-providing a voice connection. The variable configuration allows the manufacturer of the vehicle and/or the occupant of the vehicle to variably determine the number of unsuccessful connection attempts, i.e. to set them as desired.

The emergency call control device is advantageously designed to provide a voice connection to a primary control center and/or to a secondary control center either optionally or automatically. The configuration of the emergency call control device can include an address, such as a telephone number, of the secondary control center. The variable configuration may allow the manufacturer of the vehicle and/or the occupant of the vehicle to set whether the voice connection is provided optionally, i.e. after confirmation by the occupant, or automatically.

Another example of the invention is a vehicle with an emergency call control device. The vehicle can be designed according to the invention simply by replacing an existing control device. Emergency call control devices that go hand in hand with many possible applications of the invention belong to a large number of vehicles.

According to an example of the invention, the emergency call control device is an emergency call control device according to an embodiment of the invention. Thanks to the emergency call control device, an automatically provided and successful voice connection is ensured in the event of an accident with the vehicle and the safety of the vehicle is increased.

An advantage of the method according to an example of the invention is that a failure of an automatically provided voice connection is reliably detected and, when the failure is detected, a success of the voice connection is ensured by further connection attempts. In this way, the safety of a vehicle and an occupant of the vehicle is increased.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 shows a block diagram of a vehicle according to an example of an embodiment of the invention.

### DETAILED DESCRIPTION

Reference will now be made in detail to the preferred embodiments, examples of which are illustrated in the accompanying drawings, wherein like reference numerals refer to like elements throughout.

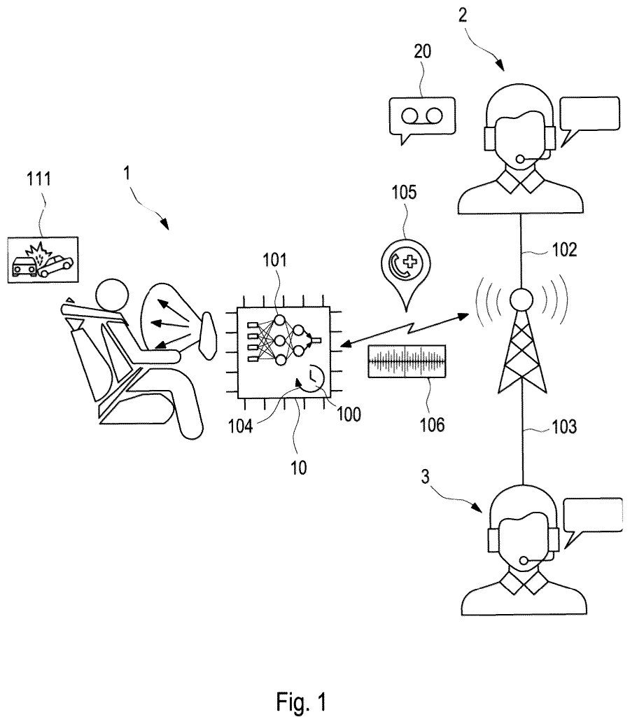

FIG. 1 shows a block diagram of a vehicle 1 according to an example of an embodiment of the invention. The vehicle 1 includes an emergency call control device 10 according to an embodiment of the invention, which is suitable for the vehicle 1. The emergency call control device 10 includes a duration measurement module 100 for measuring a duration of a provided voice connection 102.

The emergency call control device 10 may also include an artificial neural network 101 and/or may have a variable configuration for determining a number of unsuccessful connection attempts for re-providing a voice connection 102. In addition, the emergency call control device 10 may be designed to optionally or automatically provide a voice connection 102, 103 to a primary control center 2 and/or to a secondary control center 3.

The emergency call control device 10 is designed to carry out a method described below according to an embodiment of the invention for placing an emergency call 105 from the vehicle 1.

The emergency call control device 10 of the vehicle 1 detects an accident event 111 and automatically places an emergency call 105 based on the detected accident event 111.

In addition, the emergency call control device 10 establishes a voice connection 102 to a primary control center 2.

When the provided voice connection 102 ends and a duration of the terminated voice connection 102 measured by a duration measurement module 100 of the emergency call control device 10 is less than a predetermined minimum duration 104, the emergency call control device 10 automatically re-provides the voice connection 102.

Re-providing can include a predetermined number of unsuccessful connection attempts. Preferably, after a certain number of unsuccessful connection attempts, a further voice connection 103 is provided to a secondary control center 3.

Apart from this, the emergency call control device 10 can analyze a call 106, i.e. an electronically transmitted audio signal, during the provided voice connection 102 and can provide a further voice connection 103 to the secondary control center 3 when the analyzed call 106 includes a pre-recorded announcement 20 of the primary control center 2. In particular, the artificial neural network 101 of the emergency call control device 10 can analyze the call 106.

In an example, the emergency call control device 10 re-establishes the further voice connection 103 when the provided further voice connection 103 ends and a duration of the provided further voice connection 103 measured by the duration measurement module 100 is less than the predetermined minimum duration 104.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

### LIST OF REFERENCE SIGNS

1 Vehicle
10 Emergency call control device
100 Duration measurement module
101 Artificial neural network
102 Voice connection
103 Further voice connection
104 Minimum duration
105 Emergency call
106 Call
111 Accident event
2 Primary control center
20 Pre-recorded announcement
3 Secondary control center

1-10. (canceled)

11. A method for placing an emergency call of a vehicle, comprising:
detecting, by an emergency call control unit of the vehicle, an accident event;
by the emergency call control unit, automatically placing an emergency call based on the detected accident event and providing a voice connection to a primary control center;
measuring, by a duration measurement module of the emergency call control unit, a duration of the provided voice connection,
automatically re-providing, by the emergency call control unit, the voice connection when the provided voice connection terminates and the duration of the provided voice connection measured by the duration measurement module is less than a predetermined minimum duration, and
by the emergency call control unit, analyzing a call during the provided voice connection and providing a further voice connection to a secondary control center when the analyzed call includes a pre-recorded announcement of the primary control center.

12. The method as claimed in claim 11, wherein the automatically re-providing includes providing a predetermined number of unsuccessful connection attempts.

13. The method as claimed in claim 12, further comprising providing a further voice connection to the secondary control center after the predetermined number of unsuccessful connection attempts.

14. The method as claimed in claim 11, wherein the analyzing includes analyzing, by an artificial neural network of the emergency call control unit, the call.

15. The method as claimed in claim 12, wherein the analyzing includes analyzing, by an artificial neural network of the emergency call control unit, the call.

16. The method as claimed in claim 13, wherein the analyzing includes analyzing, by an artificial neural network of the emergency call control unit, the call.

17. The method as claimed in claim 11, further comprising re-providing, by the emergency call control unit, the further voice connection when the provided further voice connection terminates and a duration of the provided further voice connection measured by the duration measurement module is less than the predetermined minimum duration.

18. The method as claimed in claim 12, further comprising re-providing, by the emergency call control unit, the further voice connection when the provided further voice connection terminates and a duration of the provided further voice connection measured by the duration measurement module is less than the predetermined minimum duration.

19. The method as claimed in claim 13, further comprising re-providing, by the emergency call control unit, the further voice connection when the provided further voice connection terminates and a duration of the provided further voice connection measured by the duration measurement module is less than the predetermined minimum duration.

20. The method as claimed in claim 14, further comprising re-providing, by the emergency call control unit, the further voice connection when the provided further voice connection terminates and a duration of the provided further voice connection measured by the duration measurement module is less than the predetermined minimum duration.

21. An emergency call control unit for a vehicle, the emergency call unit comprising a duration measurement module to measure a duration of a provided voice connection, the emergency call control unit to execute a method as claimed in claim 11.

22. An emergency call control unit for a vehicle, the emergency call unit comprising a duration measurement module to measure a duration of a provided voice connection, the emergency call control unit to execute a method as claimed in claim 12.

23. An emergency call control unit for a vehicle, the emergency call unit comprising a duration measurement module to measure a duration of a provided voice connection, the emergency call control unit to execute a method as claimed in claim 13.

24. An emergency call control unit for a vehicle, the emergency call unit comprising a duration measurement module to measure a duration of a provided voice connection, the emergency call control unit to execute a method as claimed in claim 14.

25. An emergency call control unit for a vehicle, the emergency call unit comprising a duration measurement module to measure a duration of a provided voice connection, the emergency call control unit to execute a method as claimed in claim 15.

26. The emergency call control unit as claimed in claim 21, having a variable configuration for determining a number of unsuccessful connection attempts for re-providing a voice connection.

27. The emergency call control unit as claimed in claim 26, wherein the emergency call control unit to optionally or automatically provide a voice connection to a primary control center and/or to a secondary control center.

28. A vehicle comprising an emergency call control unit as claimed in claim 21.

29. A vehicle comprising an emergency call control unit as claimed in claim 26.

30. A vehicle comprising an emergency call control unit as claimed in claim 27.
